(19) United States
(12) Patent Application Publication
(10) Pub. No.: US 2024/0166923 A1
(43) Pub. Date: May 23, 2024

(54) UV CURABLE ADHESIVE COMPOSITION AND ARTICLES

(71) Applicant: 3M INNOVATIVE PROPERTIES COMPANY, St. Paul, MN (US)

(72) Inventors: Lijing Zhang, Shanghai (CN); Shijing Cheng, Woodbury, MN (US); Lianzhou Chen, Soodbury, MN (US); You Dao Ling, Shanghai (CN); Lin Yang, Shanghai (CN)

(21) Appl. No.: 18/550,697

(22) PCT Filed: Apr. 8, 2021
(86) PCT No.: PCT/CN2021/085962

§ 371 Date: Sep. 15, 2023

(51) Int. Cl. C09J 11/04; C09J 7/30; C09J 11/08; C09J 133/12

(52) U.S. Cl. CPC C09J 11/04; C09J 7/30; C09J 11/08; C09J 133/12; C09J 2433/00

(57) ABSTRACT

Provided is a UV curable adhesive composition, an adhesive tape comprising the UV curable adhesive composition, an adhesive film formed by UV curing of the adhesive composition, and a corresponding bonding member. The UV curable adhesive composition and the adhesive tape comprising the UV curable adhesive composition have a hybrid system of a (meth) acrylate component, epoxy resin, core-shell rubber particles, cationic photoinitiator and an amphoteric inorganic filler.

### SUMMARY

A UV curable adhesive composition is described comprising an organic component comprising a (meth)acrylate component; an epoxy resin; core-shell rubber particles; and an effective amount of a cationic photoinitiator; and up to 10 wt. % of an amphoteric inorganic filler. In some embodiments, the amphoteric inorganic filler comprises alumina trihydrate. In some embodiments, the amphoteric inorganic filler has a median particle size of 1-5 microns.

Also described is a UV curable adhesive tape or film comprising a UV curable adhesive composition layer as described herein; and articles comprising a member bonded with the UV curable adhesive described herein.

### DETAILED DESCRIPTION

The present disclosure provides a UV curable adhesive composition and a UV curable adhesive tape. The UV curable adhesive composition and the UV curable adhesive tape have a hybrid system of (meth)acrylate component/epoxy resin/core-shell rubber particles, wherein a cationic photoinitiator is used to initiate curing of the epoxy resin. The UV curable adhesive composition further comprises an amphoteric inorganic filler. The inclusion of the amphoteric inorganic filler can provide beneficial properties such as improved adhesion. This photoinitiator is induced by ultraviolet light, and even if an ultraviolet light source is removed, the photoinitiator can, at room temperature, still continue to initiate the reaction of an epoxy group, so as to finish curing (namely, living polymerization). The present disclosure further provides a UV cured adhesive film, the UV cured adhesive film comprising an adhesive composition layer formed after UV curing of the UV curable adhesive composition mentioned above.

The “UV curable” adhesive composition herein refers to an adhesive that can be defined by at least two features as follows: (i) the adhesive composition is viscous at room temperature initially and can adhere to an object surface without the need for extra heating; (ii) after the adhesive composition is adhered to the object surface, further chemical crosslinking can be triggered by ultraviolet and visible light.

### (Meth)Acrylate Component

The UV curable adhesive composition comprises a (meth)acrylate component. In some emboidments, the (meth)acrylate component is a monofunctional (meth)acrylate monomer having a single (meth)acrylate group or a multifunctional (meth)acrylate monomer comprising two or more (meth)acrylate groups.

Suitable monomers include for example C1-C10 alkyl acrylate, C3-C8 cycloalkyl acrylate, C6-C12 aryl acrylate, C1-C10 alkyl methacrylate, C3-C8 cycloalkyl methacrylate and C6-C12 aryl methacrylate, wherein C1-C10 alkyl, C3-C8 cycloalkyl and C6-C12 aryl may be substituted by one or a plurality of substituents. The substituent may be independently selected from hydroxy, carboxy, and epoxy; and the substituent may also be C3-C8 cycloalkyl, C6-C12 aryl or C6-C12 aryloxy optionally substituted by hydroxy, carboxy or epoxy. Examples of C1-C10 alkyl acrylate include, but are not limited to one or a plurality of methyl acrylate, ethyl acrylate, propyl acrylate, isopropyl acrylate, butyl acrylate, isobutyl acrylate, t-butyl acrylate, and hexyl acrylate. Examples of C1-C10 alkyl methacrylate include, but are not limited to methyl methacrylate, ethyl methacrylate, propyl methacrylate, isopropyl methacrylate, butyl methacrylate, isobutyl methacrylate, t-butyl methacrylate, or hexyl methacrylate and the like. Examples of C3-C8 cycloalkyl acrylate include, but are not limited to cyclopropyl acrylate, cyclobutyl acrylate, cyclopentyl acrylate, or cyclohexyl acrylate, and the like. Examples of C3-C8 cycloalkyl methacrylate include, but are not limited to cyclopropyl methacrylate, cyclobutyl methacrylate, cyclopentyl methacrylate, or cyclohexyl methacrylate, and the like. Examples of C6-C12 aryl acrylate include, but are not limited to phenyl acrylate, or naphthyl acrylate, and the like. Examples of C6-C12 aryl methacrylate include, but are not limited to phenyl methacrylate, or naphthyl methacrylate, and the like.

When the (meth)acrylate monomer comprises a substituent selected from hydroxy, carboxy, and epoxy; the (meth)acrylate monomer may be characterized as a reactive (meth)acrylate monomer. Some examples of reactive monomers carrying epoxy include, but are not limited to glycidyl methacrylate (GMA), or (3,4-epoxy-cyclohexylmethyl)acrylate (ECA) and the like. Due to the use of a cationic photoinitiation system, the reactive functional group of the reactive (meth)acrylate monomer suitable for the present disclosure is preferably a reactive functional group containing no nitrogen, and preferably a reactive functional group containing no sulfur.

In some embodiments, the (meth)acrylate component comprises a poly(meth)acrylate, i.e. is polyacrylate and polymethacrylate prepared by polymerizing various acrylate and/or methacrylate monomers.

Poly(meth)acrylate includes homopolymers and copolymers (.e.g random and block copolymer) prepared from various (emth)acrylate monomers. For example, polyacrylate may include C1-C10 alkyl polyacrylate, C3-C8 cycloalkyl polyacrylate, C6-C12 aryl polyacrylate, C1-C10 alkyl polymethacrylate, C3-C8 cycloalkyl polymethacrylate, or C6-C12 aryl polymethacrylate; polyacrylate may also include a copolymer of blocks of at least one C1-C10 alkyl polyacrylate, C3-C8 cycloalkyl polyacrylate, C6-C12 aryl polyacrylate, C1-C10 alkyl polymethacrylate, C3-C8 cycloalkyl polymethacrylate or C6-C12 aryl polymethacrylate, wherein C1-C10 alkyl, C3-C8 cycloalkyl and C6-C12 aryl may be substituted by one or a plurality of substituents; the substituent may be independently selected from the group consisting of hydroxy, carboxy, and epoxy; and the substituent may also be C3-C8 cycloalkyl, C6-C12 aryl or C6-C12 aryloxy optionally substituted by hydroxy, carboxy, or epoxy.

When the poly(meth)acrylate comprises a substituent selected from hydroxy, carboxy, and epoxy; the poly(meth)acrylate may be characterized as a reactive poly(meth)acrylate. Due to the use of a cationic photoinitiation system, the reactive functional group of the reactive polyacrylate suitable for the present disclosure is preferably a reactive functional group containing no nitrogen, and preferably a reactive functional group containing no sulfur.

The above-mentioned reactive polyacrylate carrying a reactive functional group can be synthesized by a conventional method of solvent free-radical polymerization. Solvents that may be used include but are not limited to ester, alcohol, ketone, carboxylic acid, aliphatic hydrocarbon, cyclane, haloalkane, or aromatic hydrocarbon, and the like; examples of the solvents include but are not limited to one or a plurality of ethyl acetate, n-butanol, acetone, acetic acid, benzene, toluene, ethylbenzene, isopropylbenzene, t-butylbenzene, heptane, cyclohexane, chloro-n-butane, bromo-n-butane, and iodo-n-butane, and the like. Initiators that can be used in the process of synthesizing the reactive polyacrylate include but are not limited to azo initiators and peroxy initiators, and examples thereof include but are not limited to azodiisobutyronitrile (AIBN), azobisisoheptonitrile (ABVN), 2,2′-azo-bi(2-methylbutyronitrile) (AMBN), benzoyl peroxide (BPO), or persulfate, and the like.

Based on the total amount of polyacrylate being 100 wt %, reactive groups such as epoxy, hydroxy, or carboxy are generally synthesized by polymerization of monomers containing these reactive groups, and the proportion of such monomers based on polyacrylate is typically at least 1.5 or 2 wt. % and no greater than 30, 25, or 20 wt. %. In some emboidments, the amount of polymerized units of monomers containing reactive groups is at least 3, 4, 5, or 6 wt. %. If the content having reactive groups such as epoxy, hydroxy or carboxy is too low, then it is difficult to form an interpenetrating polymer network (IPN), thereby influencing the temperature tolerance of the UV curable adhesive compositions. If the content having monomers with reactive groups such as epoxy, then hydroxy or carboxy is too high, and the crosslinking density of the UV curable adhesive composition may be too high, thereby making the composition brittle.

In some embodiments, the (meth)acrylate component has a glass transition temperature of at least −35° C., −30° C., −25° C. or −20° C. In some embodiments, the (meth)acrylate component has a glass transition temperature of no greater than 10° C., 5° C., 0° C., −5° C. or −10° C. When the glass transition temperature of the (meth)acrylate component is in the above-mentioned range, the (meth)acrylate component has good compatibility with the core-shell rubber. The UV curable adhesive composition containing (meth)acrylate component within the glass transition temperature range can have both good peel strength and overlap shear strength at the same time, and also have good impact resistance after curing. When the content of (meth)acrylate component in the UV curable adhesive composition is too low, the content of the epoxy resin is correspondingly too high, and the peel force and impact resistance of the cured adhesive may be worse.

In some embodiments, the UV curable adhesive composition comprises at least one (meth)acrylate component, such as a reactive polyacrylate, in an amount of at least 20, 25, 30 or 35 wt. % of the total organic component of the adhesive composition. In some embodiments, the UV curable adhesive composition comprises at least one (meth)polyacrylate, such as a reactive polyacrylate, in an amount no greater than 85, 80, 75, 70, 65, 60, 55, 50, or 45 wt. % of the total organic component of the adhesive composition. The organic component includes the reactive polyacrylate, epoxy resin, and other organic components. The organic component does not include the amphoteric inorganic filler. When the content of reactive polyacrylate is in the above-mentioned range, the (meth)acrylate component (e.g. reactive polyacrylate) has good compatibility with the epoxy resin and core-shell rubber particles. Moreover, the UV curable adhesive composition containing the (meth)acrylate component (e.g. reactive polyacrylate) of this content has good comprehensive bonding strength and good toughness after curing.

### Epoxy Resin

The UV curable adhesive composition comprises at least one epoxy resin. Due to the use of a cationic photoinitiator, the epoxy resin preferably lacks a nitrogen-containing functional group. In typical embodiments, the epoxy resin contains two or more epoxy groups in the molecule. Specifically, well-known epoxy resins obtained by reaction of a polyphenol such as bisphenol A, bisphenol F, bisphenol S, hexahydrobisphenol A, tetramethyl bisphenol A, diaryl bisphenol A, and tetramethyl bisphenol F with epichlorohydrin may be used; examples of the well-known epoxy resins include glycidyl ether, cycloaliphatic epoxy resins, epoxidized polyolefins, and the like. In the present disclosure, the liquid epoxy resin refers to an epoxy resin that is a liquid at room temperature. According to some particular embodiments of the present disclosure, the liquid epoxy resin may be a liquid epoxy resin having an epoxy equivalent of 176 to 330 g/eq. For example, examples of the liquid epoxy resin include but are not limited to liquid epoxy resins derived from bisphenol A, such as EPOKUKDO YD128 (epoxy equivalent: approximately 187) commercially available from Kunshan (Kudko) Chemical (Korea); NEPL-128 (epoxy equivalent: approximately 184-190) commercially available from Taiwan Nanya Resin Co., Ltd.; DER331 (epoxy equivalent: approximately 182-192) from Dow Chemical Corporation; E-51 (epoxy equivalent: approximately 185-210) from Blue Star Material (Wuxi) Co., Ltd.; or EPON 828 (epoxy equivalent: approximately 185-192) from Shell Oil.

In some embodiments, the epoxy resin is preferably a mixture comprised of a liquid epoxy resin and a solid epoxy resin. A combination of solid epoxy resin and the liquid epoxy resin can improve the bonding strength through a synergistic effect.

A solid epoxy resin refers to an epoxy resin that is a solid at room temperature (i.e. 25° C.). In some embodiments, the solid epoxy resin has an epoxy equivalent of 450 to 800 g/eq. Examples of solid epoxy resin include, but are not limited to solid epoxy resins derived from bisphenol A, such as NEPS-901 (epoxy equivalent: approximately 450-500) commercially available from Nan Ya Plastics (Taiwan), EPOKUKDO YD011 (epoxy equivalent: approximately 450-500) commercially available from Korea Kudko Chemical (Kunshan) Co., Ltd., E-20 (epoxy equivalent: approximately 440-550) from Blue Star Material (Wuxi) Co., Ltd., DER661 (epoxy equivalent: approximately 500-560) from Dow Chemical Corporation, or EPON1001 (epoxy equivalent: approximately 525-550) from Shell Oil.

When the UV curable adhesive composition comprises both a liquid epoxy resin and a solid epoxy resin, the amount of the liquid epoxy resin is typically at least 15, 20, 25, or 30 wt. % of the total organic component of the UV adhesive composition. In some embodiments, the amount of liquid epoxy resin is no greater than 45, 40, 35 or 30 wt. % of the total organic component of the adhesive composition.

When the UV curable adhesive composition comprises both a liquid epoxy resin and a solid epoxy resin, the solid epoxy resin is typically at least 5, 10 or 15 wt. % of the total organic component of the adhesive composition. In some emboidments, the amount of solid epoxy resin is no greater than 30, 25, 20 or 15 wt. % of the total organic component of the adhesive composition.

The total amount of epoxy resin is typically at least 20, 25, 30, 35 or 40 wt. % of the total organic component of the adhesive composition. In some embodiments, the total amount of epoxy resin is no greater than 50 wt. % of the total organic component of the UV curable adhesive composition. When the total amount of the epoxy resin components is too high, the peel force and impact resistance of the cured adhesive are significantly degraded.

### Cationic Photoinitiator

Although the photoinitiator is present in a small amount in the UV curable adhesive composition of the hybrid system of reactive polyacrylate carrying a reactive functional group/epoxy resin, the photoinitiator has a significant effect on the cure speed and storage stability of the UV curable adhesive composition.

Suitable cationic photoinitiators include compounds such as diaryliodonium salts, triarylsulfonium salts, alkylsulfonium salts, iron arene salts, sulfonyloxy ketones, and triaryl siloxyethers. In some embodiments, the following compounds are used: triarylsulfonium hexafluorophosphate salts or hexafluoroantimonate salts, sulfonium hexafluoroantimonate salts, sulfonium hexafluorophosphate salts, and iodonium hexafluorophosphate salts.

Onium salt photoinitiators suitable for the present disclosure include iodonium and sulfonium complex salts. Useful aromatic iodonium complex salts include a salt of a general formula as follows:

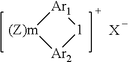

Ar₁ and Ar₂ are identical or different, each comprising aryl having about 4 to 20 carbon atoms. Z is selected from the group consisting of oxygen, sulfur, carbon-carbon bonds:

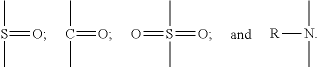

R may be aryl (having about 6 to 20 carbon atoms, such as phenyl) or acyl (having about 2 to 20 carbon atoms, such as acetyl or benzoyl); and

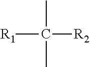

R₁ and R2 are selected from the group consisting of hydrogen, alkyl having about 1 to 4 carbon atoms, and alkenyl having about 2 to 4 carbon atoms.
m is 0 or 1; and
X has a chemical formula of DQₙ, wherein D is a metal of Groups IB to VIII or a nonmetal of Groups IIIA to VA in the Periodic Table of Elements; Q is a halogen atom; and n is an integer from 1 to 6. The metal is preferably copper, zinc, titanium, vanadium, chromium, magnesium, manganese, iron, cobalt, or nickel, and the nonmetal is preferably boron, aluminum, antimony, tin, arsenic and phosphorus. Halogen Q is preferably chlorine or fluorine. Suitable examples of anions include but are not limited to BF₄⁻, PF₆⁻, SbF₆⁻, FeCl₄⁻, SnCl₅⁻, AsF₆⁻, SbF₅OH⁻, SbCl₆⁻, SbF₅⁻², AlF₂⁻², GaCl₄⁻, InF₄⁻, TiF₆⁻², ZrF₆⁻, and CF₃SO₃⁻. The anions are preferably BF₄⁻, PF₆⁻, SbF₆⁻, AsF₆⁻, SbF₅OH⁻, and SbCl₆⁻. More preferably, the anions are SbF₆⁻, AsF₆⁻ and SbF₅OH⁻.

More preferably, Ar₁ and Ar₂ are selected from the group consisting of phenyl group, thienyl group, furanyl group, and pyrazolyl group. The Ar₁ and Ar₂ groups may optionally comprise one or a plurality of condensed benzocycles (e.g., naphthyl, benzothienyl, dibenzothienyl, benzofuranyl, and dibenzofuranyl). The aryl groups may also be substituted by one or a plurality of non-alkaline groups as required, if they do not substantially react with epoxy compounds and hydroxy functional groups.

Suitable aromatic sulfonium complex salt initiators may be represented by the following general formula:

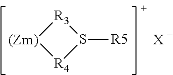

wherein R₃, R₄, and R₅ are identical or different, provided that at least one of R₃, R₄ and R₅ is aryl. R₃, R₄ and R₅ may be selected from the group consisting of aromatic portions comprising about 4 to 20 carbon atoms (e.g., substituted and unsubstituted phenyl, thienyl and furyl) and alkyl comprising about 1 to 20 carbon atoms. R₃, R₄ and R₅ are each preferably an aromatic portion; and Z, m and X are all those as defined for the iodonium complex salt above.

In some emboidments, R₃, R₄ and R₅ are aromatic groups, that optionally comprise one or a plurality of condensed benzocycles (e.g., naphthyl, benzothienyl, dibenzothienyl, benzofuranyl, and dibenzofuranyl). The aryl groups may also be substituted by one or a plurality of non-alkaline groups as required, if they do not substantially react with epoxy compounds and hydroxy functional groups.

Useful sulfonium salts include triaryl substituted salts, specifically such as triphenyl sulfonium hexafluoroantimonate and p-phenyl(thiophenyl)biphenyl sulfonium hexafluoroantimonate. Other sulfonium salts useful in the present disclosure have been described in U.S. Pat. Nos. 4,256,828 and 4,173,476.

Another suitable photoinitiator comprises photoactivatable organic metal complex salts, such as those described in U.S. Pat. Nos. 5,059,701; 5,191,101; and 5,252,694. These organic metal cationic salts have a general formula as follows:

[(L₁)(L₂)Mm]e⁺X⁻
wherein Mm represents an element selected from the periodic table IVB, VB, VIB, VIIB, and VIII, and is preferably Cr, Mo, W, Mn, Re, Fe and Co; L₁ represents 0, 1 or 2 ligands that contribute pi electrons, wherein the ligands may be identical or different, each of which may be selected from the group consisting of substituted and unsubstituted alicyclic and cyclic unsaturated compound substituted and unsubstituted carbocyclic aromatics and heterocyclic aromatics. Each of the compounds may contribute 2 to 12 pi electrons to a valence shell of the metal atom M. L₁ is preferably selected from the group consisting of substituted and unsubstituted η3-allyl, η5-cyclopentadienyl and η7-cycloheptane compounds, and η6-aromatics from η6-benzene and substituted η6-benzene compounds (e.g., xylene) and compounds with 2-4 fused rings, each ring being able to contribute 3 to 8 pi electrons to the valence shell of metal atom M.

L₂ represents 0, or 1 to 3 ligands that contribute an even number of pi electrons, wherein the ligands may be identical or different, each of which may be selected from the group consisting of carbon monoxide, nitrosonium, triphenylphosphine, antimony triphenyl, and phosphorus, arsenic and antimony derivatives, provided that the total electrical charge contributed to Mm by L₁ and L₂ result in e net residual positive charge of the complex.

e is an integer of 1 or 2, the residual charge in coordination with cations; and X is a halogen-containing anion in coordination, as stated above.

Examples of suitable organic metal coordinated cationic salts serving as photoactivatable catalysts include, but are not limited to the following:
[(η6-benzene)(η5-cyclopentadienyl)Fe]⁺[SbF₆]⁻,
[(η6-toluene)(η5-cyclopentadienyl)Fe]⁺[AsF₆]⁻,
[(η6-xylene)(η5-cyclopentadienyl)Fe]⁺[SbF₆]⁻,
[(η6-isopropylbenzene)(η5-cyclopentadienyl)Fe]⁺[SbF₆]⁻,
[(η6-xylene (mixed isomer))(η5-cyclopentadienyl)Fe]⁺[SbF₆]⁻,
[(η6-xylene (mixed isomer))(η5-cyclopentadienyl)Fe]⁺[PF₆]⁻,
[(η6-o-xylene)(η5-cyclopentadienyl)Fe]⁺[CF₃SO₃]⁻,
[(η6-m-xylene)(η5-cyclopentadienyl)Fe]⁺[BF₄]⁻,
[(η6-1,3,5-trimethylbenzene)(η5-cyclopentadienyl)Fe]⁺[SbF₆]⁻,
[(η6-hexamethylbenzene)(η5-cyclopentadienyl)Fe]⁺[SbF₅OH]⁻,
[(η6-fluorene)(η5-cyclopentadienyl)Fe]⁺[SbF₆]⁻.

In one emboidment, the organic metal coordinated cationic salt comprises one or a plurality of the following compounds:
[(η6-xylene (mixed isomer))(η5-cyclopentadienyl)Fe]⁺[SbF₆]⁻,
[(η6-xylene (mixed isomer))(η5-cyclopentadienyl)Fe]⁺[PF₆]⁻,
[(η6-xylene)(η5-cyclopentadienyl)Fe]⁺[SbF₆]⁻,
[(η6-1,3,5-trimethylbenzene)(η5-cyclopentadienyl)Fe]⁺[SbF₆]⁻,

Suitable commercially available initiators include, but are not limited to DOUBLECURE1176; 1193 (Double Bond Chemical Ind. Co., Ltd.); IRGACURE 261, a cationic organic metal complex salt (BASF); and OMNICAT 250 (Former Irgacure 250) by IGM Resins is a cationic photoinitiator (a 75% solution Iodonium, (4-methylphenyl)[4-(2-methylpropyl)phenyl]-, hexafluorophosphate(1-) in propylene carbonate).

The UV curable adhesive composition may optionally comprise a sensitizer, such as “OMNIRAD ITX”, that can improve the efficiency of iodonium salts.

The UV curable adhesive composition comprises an effective amount of cationic photoinitiator that is typically at least 0.02, 0.05, 0.1, 0.2, 0.3, 0.4 or 0.5 wt. % of the total adhesive composition. In some embodiments, the amount of photoinitiator is no greater than 10, 9, 8, 7, 6, 5, 4, 3, 2, or 1 wt. % of the total adhesive composition. When the content of the cationic photoinitiator is too low, then the requirement of UV radiation energy is high and/or the cure speed is too slow. On the contrary, if the content of the cationic photoinitiator is too high, the adhesive composition can be cured even under sunlight or a fluorescent lamp (containing a small amount of UV light), thereby influencing the room temperature storage stability of the UV curable adhesive composition.

### Core-Shell Rubber (CSR) Particles

The core-shell rubber particle refers to a particulate material having a rubber core. A core refers to the internal portion of the core-shell rubber. The core may be a central part forming the core-shell particle or an inner shell area of the core-shell rubber. A shell is a portion of the core-shell rubber located outside the rubber core, and may be one or a plurality of shell portions that usually form the outermost portion of the core-shell rubber particle. The shell material is preferably grafted or crosslinked onto the core, or both. The rubber core may account for 50% to 95% based on the weight of the core-shell rubber particle.

The core of the core-shell rubber suitable for the present invention may be formed by conjugated dienes, e.g., butadiene; low-grade alkyl esters of acrylic acid, e.g., n-butyl acrylate, ethyl ester, isobutyl ester; 2-ethylhexyl ester; or polymers or copolymers of polysiloxane. Specifically, the cores of CSR particles may be one or a plurality of substances selected from the following group consisting of methyl methacrylate butadiene styrene (MBS) monomers, methacrylate-acrylonitrile-butadiene-styrene (MABS) monomers, or combinations thereof. Examples of other compounds that can be used to form the core include ABS (acrylonitrile-butadiene-styrene), ASA (acrylate-styrene-acrylonitrile), acrylic substances, SAEPDM (styrene-acrylonitrile grafted onto the elastomer backbone of an ethylene-acrylic diene monomer), MAS (methacrylic-acrylic rubber styrene) and the like, and mixtures thereof. The size of CSR particles is generally at least 50 pr 100 nm and typically no greater than 300 nm, and the CSR particles are prepared through emulsion polymerization reaction. Kaneka Kane Ace MX series products commercially available from Japan are preferred.

The shell suitable for the core-shell rubber may comprise one or a plurality of acrylic polymers or acrylic copolymers. Specifically, the shell of a CSR particle may be formed of acrylic polymers, acrylic copolymers, or combinations thereof. In multiple embodiments, the (polymer) composition forming the shell of the core-shell rubber has sufficient affinity for the epoxy resin and (meth)acrylate component used as a matrix, to allow the core-shell rubber particles to exist as primary particles in the adhesive tape in solid form, and to stably disperse. Preferred CSR particles have polybutadiene rubber cores or styrene butadiene rubber cores (e.g., formed of MB S monomers) and shells formed of acrylic polymers or acrylic copolymers, wherein the core-shell rubber is optionally dispersed in the matrix, and the matrix is preferably selected from the group consisting of aromatic epoxy resins, particularly bisphenol A, F-based diglycidyl ether, and hydroxy compounds.

In some embodiments, UV curable adhesive composition comprises core-shell rubber is an amount of at least 0.5, 1, 2, 3, 4, 5, 5, 7, 8, 9, or 10 wt. % of the total organic component of the adhesive composition. In some embodiments, UV curable adhesive composition comprises core-shell rubber is an amount no greater than 20, 15 or 10 wt. % of the total organic component of the adhesive composition.

In some embodiments, the core-shell rubber is dispersed in an epoxy or polyol medium, and especially in a polyol, the core-shell rubber particles are dispersed more uniformly and have better compatibility with (meth)acrylate component and epoxy resin used as the matrix.

### Hydroxy-Containing Compounds

The UV curable adhesive composition optionally comprises hydroxy-containing compounds. The hydroxy-containing compounds include ether or ester derivatives thereof. In some embodiments, the hydroxy-containing compounds are polyols. When the epoxy group reacts through the cationic mechanism, the hydroxy-containing compound acts as a chain transfer agent, and the hydroxy-containing compound has a good dispersing effect on the core-shell rubber particles, making the core-shell rubber particles more compatible with the epoxy resin and (meth)acrylate component used as the matrix.

Suitable polyols include for example polyether polyols and polyester polyols. The polyether polyol includes, but is not limited to, one or a plurality from the group consisting of polyether triols and polyether diols. The polyester polyol includes, but is not limited to, one or a plurality from the group consisting of polyester triols, polyester diols, and bisphenol A polyols. In some embodiments, the polyol may be selected from TONE 0230 Polyol, VORANOL 230-238 and VORANOL 2070, all commercially available from Dow Chemical Company, U.S.; and Dianol 285 commercially available from Seppic Corporation, France, etc. In one embodiment, the polyol is VORANOL 2070 commercially available from Dow Chemical Company, U.S., which is a polyether triol having a molecular weight of 700.

In some embodiments, the UV curable adhesive composition typically comprise a hydroxyl-functional component, such as a polyol, in an amount of at least 1, 1.5, 2, 1.5 or 3 wt. % of the total organic component of the adhesive composition. In some embodiments, the amount of hydroxyl-functional component, such as a polyol is no greater than 20, 15, 1, or 5 wt. % of the total organic component of the adhesive composition.

### Amphoteric Inorganic Filler

The UV curable adhesive composition comprises at least one amphoteric inorganic filler. As demonstrated in the forthcoming examples, it has been found that small concentrations of alumina trihydrate can improve the peel adhesion. In some embodiments, the initial peel (prior to curing) and/or cured peel (after curing) is at least 0.6, 0.7, or 0.8 N/mm and typically not greater than 1 N/mm In some embodiments, the cured peel (peel after curing) is at least 0.6, 0.7, 0.8, 1.0 N/mm. In some emboidments, the initial peel and/or cured peel is no greater than 2 or 1.5 N/mm. In some embodiments, the adhesive composition exhibits an increase in cured peel (peel after curing) of at least 0.1, 0.2, 0.3, 0.4, 0.5, 0.6, 0.7, 0.8, or 1.0 N/mm relative to the same composition without the amphoteric inorganic filler.

In typical embodiments, the amount of amphoteric inorganic filler such as alumina trihydrate is at least 0.005, 0.1, 0.2, 0.3, 0.4, or 0.5 wt. % of the total adhesive composition. In typical embodiments, the amount of amphoteric inorganic filler such as alumina trihydrate is no greater than 10, 9, 8, 7, 6, 5, 4, 3, 2 or 1 wt. %. Thus, the amount of alumina trihydrate is too low to provide significant flame retardency or thermal conductivity.

The amphoteric inorganic filler typically has a median particle size of no greater than 50, 40, 30, 20, 10 or 5 microns. In some embodiments, the amphoteric inorganc filler has a median particle size of at least 0.01 or 0.1 microns. In some emboidments, the amphoteric inorganic filler has a median particle size of 1-2 microns.

One illustrative amphoteric inorganic filler is alumina trihydrate. Alumina trihydrate, also referred to as aluminum hydroxide has the formula Al₂(OH)₃ and a molecular weight of 78 g/mole. In some emboidments, the alumina trihydrate has as a distribution of particles such that 90, 95, or 100% of the particles pass through a 325 mesh. In some embodiments, the alumina trihydrate has as a surface area (as measured with a Quantachrome monosorb surface area analyzer) of at least 10 or 15 m²/gm and no greater than 20 m²/gm. In some embodiments, the alumina trihydrate has a specific gravity of about 2.4 gm/cm³.

Aluminum hydroxide is described as amphoteric. Aluminum hydroxide can act as weak base when reacting with a strong acid. Without intending to be bound by theory, it is surmised that the aluminum hydroxide may react with (e.g. residual) cationic photoinitiator thereby reducing the amount of residual acid.

In bases, aluminum hydroxide can act as a Lewis acid by binding hydroxyl ions. Without intending to be bound by theory, it is surmised that the aluminum hydroxide may react with (e.g. residual) hydroxyl-containing component thereby reducing the amount of residual hydroxyl-containing component.

It is contemplated that other amphoteric metal oxides may provide similar improvements as alumina trihydrate. For example, magnesium oxide and magnesium hydroxide are also considered to be amphoteric or, in other words, a weak base.

### Other Additives

Common additives may be present in the UV curable adhesive composition to achieve the necessary physical or chemical properties required for specific applications. Adhesion promoters, crosslinkers, tackifying resins, inorganic fillers and the like are included in the present application.

The UV curable adhesive composition may comprise an adhesion promoter. A suitable adhesion promoter can be selected according to the surface to be bonded. The inventor has found that silane is an additive that improves the adhesion of the UV curable adhesive tape to metal (e.g. aluminum, stainless steel) and glass without influencing the UV curing reaction. Epoxy-containing reactive silanes are preferred, such as commercially available Silquest A187 (Momentive Performance Materials).

The UV curable adhesive composition may comprise a crosslinker. Preferred crosslinkers can be reacted and crosslinked with reactive polypropionate and include difunctional or polyfunctional isocyanates, and difunctional or polyfunctional amines. An important criterion for selection of a crosslinker is that the crosslinker has no possible or the lowest possible influence on the UV cationic polymerization reaction.

The UV curable adhesive composition may comprise a tackifying resin. Such as rosin acid, rosin ester, terpene phenolic resin, hydrocarbon resin and Benzofuran indene resin. The type and amount of the tackifiers may have effect on tack, wetting, adhesion strength, and heat resistance performance.

The UV curable adhesive composition may comprise an inorganic filler. For example, fumed silica, aluminium oxide, conductive fillers, et.al. For example, Waker HDK H15, HDK H20, CAB-O-SIL TS-610.

In another embodiment, a UV curable adhesive tape is described comprising at least one UV curable adhesive composition layer disposed on a substrate. In some embodiments, the thickness of the adhesive layer (thickness of the dried adhesive) may be between 10 and 100 μm.

The UV curable adhesive tape can be prepared by the following steps: coating the UV curable adhesive composition of the present disclosure in a flowable form onto a substrate layer (e.g., a layer) by a conventional coating method, and then removing the solvent by heating, to thereby form an adhesive film of a certain thickness, so as to obtain the UV curable adhesive tape.

The UV curable adhesive composition used for coating having viscosity that is too high or too low is unfavorable to the coating of the UV curable adhesive composition. A solvent, e.g., an ester, an alcohol, a ketone, a carboxylic acid, an aliphatic hydrocarbon, a cyclane, a haloalkane, an aromatic hydrocarbon, etc., may be added in order to adjust the viscosity. Examples of the solvent include but are not limited to one or a plurality from the group consisting of ethyl acetate, n-butanol, isopropanol, acetone, acetic acid, benzene, toluene, ethylbenzene, isopropylbenzene, t-butylbenzene, heptane, cyclohexane, 1-chlorobutane, 1-bromobutane, and 1-iodobutane.

Useful coating methods include roll knife coating, comma roll coating, dragging blade coating, reverse roll coating, winding bar (Mayer) coating, gravure roll coating, slit-type die extrusion (Die) coating, and the like. Preferable coating methods are comma roll coating and slit-type die extrusion (Die) coating.

In some embodiments, the substrate of the tape is single-sided release (e.g. paper or film) liner provided on one side of the adhesive layer. The release liner can protect the adhesive layer. When in use, the release layer can be peeled off to expose the adhesive layer for use.

Unless stated otherwise, the following terms are defined as follows:

Herein, the term (meth)acrylic acid refers to acrylic acid, methacrylic acid, or both. Similarly, the term (meth)acrylate refers to acrylate, methacrylate, or both. (Meth)acrylate polymers refer to polymers where polymerization monomers are mainly acrylic acid/ester and/or methacrylic acid/ester.

Herein the glass transition temperature (Tg) of a polymer (e.g. polyacrylate) can be determined by a method commonly used in the art such as DSC, or can be calculated through the FOX equation. The FOX equation is used to describe the relationship between Tg of a copolymer and Tg of a homopolymer constituting the component of the copolymer. For example, for a copolymer constituted by monomer units A, B, C and the like, Tg thereof can be represented by following formula:

$$\frac{1}{Tg} = \frac{{W}_{A}}{{Tg}_{A}} + \frac{{W}_{B}}{{Tg}_{B}} + \frac{{W}_{C}}{{Tg}_{C}} + …$$

wherein
Tg is Tg of the copolymer;
WA, WB, WC, and the like are mass fractions of monomer units A, B, C and the like, respectively; and
TgA, TgB, TgC, and the like are Tg of the A homopolymer, B homopolymer, C homopolymer and the like, respectively.

The UV curable adhesive composition and the UV curable adhesive tape are explained in more detail below.

### EXAMPLES

Unless otherwise noted, all parts, percentages, ratios, etc. in the Examples and the rest of the specification are by weight. Unless otherwise indicated, all other reagents were obtained, or are available from fine chemical vendors such as Sigma-Aldrich Company, St. Louis, Missouri, or may be synthesized by known methods. Table 1 (below) lists materials used in the examples and their sources.

TABLE 1
Materials List

| DESIGNATION | DESCRIPTION | SOURCE |
|---|---|---|
| E828 | Liquid epoxy resin obtained under the trade designation “EPIKOTE 828” | Hexion, Columbus, OH |
| N901 | Solid epoxy resin obtained under the trade designation “NPES-901” | Nan Ya Plastic Corporation, Taiwan |
| Polyacrylate (P1) | Reactive polyacrylate, see preparation described below. | 3M Company, St. Paul, MN |
| D1190 | Cationic photoinitiator obtained under the trade designation “DOUBLECURE 1190”; | Double Bond Chemical, Taiwan |
| | solid content 40 wt. % | |
| V2070 | Polyol obtained under the trade designation “VORANOL 2070” | Dow Chemical Company, Midland, MI |
| OM-250 | Cationic photoinitiator obtained under the trade designation “OMNICAT 250”; | IGM Resins, Charlotte, NC |
| | solid content 75 wt. % | |
| OM-ITX | Sensitizer obtained under the trade designation “OMNICAT ITX” | IGM Resins |
| KH560 | Silicon-containing adhesion promoter (3-glycidoxypropyltrimethoxy silane) obtained | Nanjing Alchemist Chemical Co., Ltd |
| | under the trade designation “KH-560” | |
| CSR | 40 wt. % polybutadiene core-shell rubber (CSR) dispersed in polypropylene glycol | Kaneka Corporation of Osaka, Japan |
| | having a molecular weight of 400 g/mol; obtained under the trade designation | |
| | “KANE ACE MX-714” | |
| ATH | Alumina trihydrate filler obtained under the trade designation “MICRAL 916” | Huber Engineered Materials, Atlanta, GA |
| MA | Methyl acrylate | Shanghai Huayi, Shanghai, China |
| BA | Butyl acrylate | Shanghai Huayi |
| AA | Acrylic acid | Shanghai Huayi |
| GMA | Glycidyl methacrylate | Mitsubishi Gas Chemical, Tokyo, Japan |
| EA | Ethyl acetate | Sinopharm Group, Beijing, China |
| V67 | Initiator obtained under the trade designation “VAZO 67” | Dupont, Wilmington, DE |

### Test Methods

### Testing of Peel Force

The force needed to peel off the adhesive tape at 180° was measured. Referring to the peel force testing method ASTM D3330, the adhesive tapes from the embodiments and comparative examples were tested, specifically by testing stainless steel plates with 50 micrometers (μm) PET films as the backing. The stainless steel plates were wiped with isopropanol three times before the test. The 75 μm thick adhesive tape (backing: 50 μm PET) was cut into 0.5×8 inches (1.3×20.3 centimeters). The release film was peeled off, and the adhesive tape was attached to the stainless steel plate and rolled and pressed twice with a 2 kilogram (kg) force. Initial peel was tested after dwelling the test specimen for 20 minutes at 50% relative humidity at 24° C. For peel after UV curing, UV irradiation (LED 365 nanometers (nm), 1.5-3 J/cm²) was used to trigger a curing process. Then the test sample strips were placed in a room of controlled environment (23° C./50% relative humidity) for postcuring for about 2 days and subsequently tested. A tension tester ITS Insight equipped with a 1000N weighing sensor commercially available from MTS Systems Corporation (Eden Prairie, MN) was used to evaluate the peel bonding strength. During the testing process, 30.5 cm/minute (12 in./minute) cross head speed was used, and the samples were fixed in the bottom fixture, with the tail fixed in the top fixture at an angle of 180°. The average of two samples was reported in the unit of Newtons/millimeter (N/mm).

### Overlap Shear (Ols) Adhesion Test After Curing

A 2.5 cm width×10.2 cm length (1 inch×4 inches) aluminum panel was used to evaluate the overlap shear adhesion. The bonding surface of the panel was gently scraped with a 3M SCOTCH-BRITE NO.86 scrubbing pad (green) and then gently scraped with an isopropanol wipe to remove any loose debris. Then, the release film of the adhesive film (about 50 μm thick) with PET release films on both sides was peeled off. One side of the adhesive film was attached to about 0.5 inch (1.3 cm) of the upper end of the aluminum plate. The film was rolled and pressed twice with a 2 kg force, and then the redundant adhesive film was cut along the edge of the aluminum plate. One side of the adhesive film was irradiated with UV (LED 365 nm, 1.5-3 J/cm²) to trigger a curing process. After irradiation, the PET release film on the surface was peeled off immediately, and the aluminum plate on the other side was joined together face-to-face along the length thereof, to provide a overlap bonding area of about 1.3 cm length×2.5 cm width (0.5 inch×1 inch). The bonded test panel sample was kept under pressure for 48 hours at 23° C. (room temperature) to ensure complete curing. A tension tester ITS Insight equipped with a 25KN weighing sensor commercially available from MTS Systems Corporation (Eden Prairie, MN) was used to evaluate the peak overlap shear strength of the test samples at 22° C. at a separation rate of 2.5 mm/minute (0.1 inch/minute). The reported value was expressed as the average of three samples.

### EXAMPLES

### Preparative Example 1 (PE-1): Solvent-Based Methyl(Acrylic) Polymer P1

49 parts of MA, 44.5 parts of BA, 6 parts of AA, 0.5 part of GMA, 0.2 part of VAZO 67 and 150 parts of EA were mixed in a glass bottle. Nitrogen was fed therein for 2 minutes to remove oxygen, and the bottle was sealed. The reaction bottle was kept in the polymerization equipment at 60° C. to perform polymerization reaction for 24 hours, so as to prepare the solvent-based (methyl)acrylic polymer P1 with a solid content of 40%. Then the polymer mixture was diluted to 29 wt. %. The Tg was calculated to be −20° C. through the Fox equation.”

### Preparation of Semi-Structural Bonding Tapes EX-1 to EX-5 and CE-1 to CE-4

UV curable formulations of Table 2 were prepared according to the amounts and compositions detailed in Table 2 by uniformly mixing all components in a bottle. The mixture was then coated onto a PET silicone liner and placed in an oven at 100° C. for 10 minutes to dry. The target thickness of the dried film was 70 micrometers (μm). After the solvent drying process, another layer of PET silicone liner was placed on the adhesive film to protect the adhesive surface.

TABLE 2
Formulation of UV initiated adhesive tapes

| MATERIAL | EX-1 | EX-2 | EX-3 | EX-4 | EX-5 | CE-1 | CE-2 | CE-3 | CE-4 |
|---|---|---|---|---|---|---|---|---|---|
| P1, g | 172 | 172 | 172 | 172 | 172 | 172 | 172 | 172 | 172 |
| (wt. % solids) | (41.5) | (41.7) | (41.8) | (41.9) | (42.1) | (41.9) | (42.1) | (42.3) | (42.1) |
| E828, g | 35 | 35 | 35 | 35 | 35 | 35 | 35 | 35 | 35 |
| (wt. % solids) | (29.1) | (29.3) | (29.3) | (29.4) | (29.5) | (29.4) | (29.6) | (29.7) | (29.6) |
| N901, g | 15 | 15 | 15 | 15 | 15 | 15 | 15 | 15 | 15 |
| (wt. % solids) | (12.5) | (12.5) | (12.6) | (12.6) | (12.6) | (12.6) | (12.7) | (12.7) | (12.7) |
| D1190, g | 6 | 6 | 6 | 4.5 | | 6 | 4.5 | 3 | |
| (wt. % solids) | (2.0) | (2.0) | (2.0) | (1.5) | | (2.0) | (1.5) | (1.0) | |
| OM-250, g | | | | | 1.2 | | | | 1.6 |
| (wt. % solids) | | | | | (0.8) | | | | (1.0) |
| OM-ITX, g | | | | | 0.45 | | | | 0.6 |
| (wt. % solids) | | | | | (0.4) | | | | (0.5) |
| ATH, g | 1.2 | 0.6 | 0.24 | 0.6 | 0.6 | | | | |
| (wt. % solids) | (1.0) | (0.5) | (0.2) | (0.5) | (0.5) | | | | |
| V2070, g | 4 | 4 | 4 | 4 | 4 | 4 | 4 | 4 | 4 |
| (wt. % solids) | (3.3) | (3.3) | (3.4) | (3.4) | (3.4) | (3.4) | (3.4) | (3.4) | (3.4) |
| KH560, g | 0.25 | 0.25 | 0.25 | 0.25 | 0.25 | 0.25 | 0.25 | 0.25 | 0.25 |
| (wt. % solids) | (0.2) | (0.2) | (0.2) | (0.2) | (0.2) | (0.2) | (0.2) | (0.2) | (0.2) |
| CSR, g | 12.5 | 12.5 | 12.5 | 12.5 | 12.5 | 12.5 | 12.5 | 12.5 | 12.5 |
| (wt. % solids) | (10.4) | (10.4) | (10.5) | (10.5) | (10.5) | (10.5) | (10.6) | (10.6) | (10.6) |

TABLE 3
Adhesion performance

| | INITIAL | PEEL AFTER | |
|---|---|---|---|
| EXAMPLE | PEEL, N/mm | CURING, N/mm | OLS, MPa |
| EX-1 | 0.74 | 0.88 | 10.6 |
| EX-2 | 0.67 | 0.85 | 11.8 |
| EX-3 | 0.67 | 0.89 | 10.5 |
| EX-4 | 0.62 | 1.15 | 11.2 |
| EX-5 | 0.61 | 0.87 | 10.9 |
| CE-1 | 0.6 | 0.35 | 10 |
| CE-2 | 0.55 | 0.51 | 9.8 |
| CE-3 | 0.58 | 0.49 | 9.9 |
| CE-4 | 0.53 | 0.51 | 10.8 |

As demonstrated by the examples of Table 3, small concentrations of amphoteric inorganic filler (e.g. ATH) can provide higher peel values after curing.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A UV curable adhesive composition, comprising:
an organic component comprising
a (meth)acrylate component;
epoxy resin;
core-shell rubber particles; and
an effective amount of a cationic photoinitiator; and
up to 10 wt. % of an amphoteric inorganic filler.

2. The UV curable adhesive composition of claim 1 wherein the amphoteric inorganic filler comprises alumina trihydrate.

3. The UV curable adhesive composition of claim 1 wherein the amphoteric inorganic filler has a median particle size of 1-5 microns.

4. The UV curable adhesive composition according to claim 1, wherein the epoxy resin comprises a liquid epoxy resin.

5. The UV curable adhesive composition according to claim 4, wherein liquid epoxy resin is present in an amount from 15 to 45 wt. % of the organic component.

6. The UV curable adhesive composition according to claim 1, wherein the epoxy resin further comprises a solid epoxy resin.

7. The UV curable adhesive composition according to claim 6, wherein the solid epoxy resin is present in an amount from 5 to 30 parts wt. % of the organic component.

8. The UV curable adhesive composition according to claim 1, wherein the (meth)acrylate component is present in an amount from 30 to 50 wt. % of the organic component.

9. The UV curable adhesive composition according to claim 1, wherein the (meth)acrylate component has a glass transition temperature of no greater than 20, 15, 10, 5 or 0° C.

10. The UV curable adhesive composition according to claim 1, wherein the (meth)acrylate component comprises a reactive polyacrylate.

11. The UV curable adhesive composition according to claim 1, wherein the cationic photoinitiator is present in an amount from 0.5 to 1 part by weight.

12. The UV curable adhesive composition according to claim 1, further comprising a hydroxy-containing compound.

13. The UV curable adhesive composition according to claim 1, wherein the core-shell rubber particles comprise a core material selective from polybutadiene, styrene-butadiene rubber, polyacrylate or polysiloxane.

14. The UV curable adhesive composition according to claim 1, wherein shells of the core-shell rubber particles comprise one or a plurality of acrylic polymers or acrylic copolymers.

15. A UV curable adhesive tape or film comprising a UV curable adhesive composition layer according to any one of claim 1.

16. The UV curable adhesive tape according to claim 15, further comprising a release liner in contact with at least one major surface of the UV curable adhesive composition layer.

17. An article comprising a member bonded with the UV curable adhesive of claim 1.

18. The article of claim 17 wherein the member comprises metal.
